(19) United States
(12) Patent Application Publication
(10) Pub. No.: US 2007/0228759 A1
(43) Pub. Date: Oct. 4, 2007

(54) Clamping mechanism for carrier for bicycles and other cargo

(76) Inventor: Verlin V. Gibson, Defiance, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/393,094

(22) Filed: Mar. 30, 2006

(51) Int. Cl. B60R 9/00

(52) U.S. Cl. 296/37.6

(57) ABSTRACT

A cargo carrier (10) for bicycles removably installable in the bed (B) of a truck (T) has a base plate (12) and a plurality of saddles (14-18) which are attached to the base plate. Each saddle comprises a pair of risers. A clamping mechanism (20) includes a saddle clamp (22) and a truck clamp (24) for attaching a vertical section of the riser at each end of the side-by-side arrangement of saddles to a sidewall (E or S) of the truck bed to secure the carrier in place.

### CROSS REFERENCE TO RELATED APPLICATIONS

U.S. patent application Ser. No. 10/635,090 filed Aug. 6, 2003, and Ser. No. 11/072,157 filed Mar. 4, 2005.

### STATEMENT REGARDING FEDERALLY SPONSORED RESEARCH OR DEVELOPMENT

N/A

### BACKGROUND OF THE INVENTION

This invention relates to a cargo carrier for transporting bicycles, motorcycles, and other cargo which is loaded into the bed of a pickup truck or the like, and in particular, to a clamping mechanism which allows the carrier to be more easily installed in the truck for conveniently and safely transporting the bicycles, motorcycles, and other cargo.

In my pending U.S. patent application Ser. Nos. 10/635,090 and 11/072,157, there is described a carrier removably installed in the bed of a pickup truck. The carrier is designed for the safe transport of one or more bicycles or motorcycles, or other cargo from one location to another, even if difficult and rugged terrain is encountered. The present invention is an improvement over the carriers described in these previous applications in that it allows the carrier to be readily clamped to a sidewall of the truck bed, thereby simplyfing installation of the carrier, and obviating the need to attach a base of the carrier to the bed of the truck by drilling holes in the truck bed or the like.

### BRIEF SUMMARY OF THE INVENTION

The present invention is directed to an improved cargo carrier removably installed in the bed of a pickup truck. The improvement comprises a clamping mechanism including a pair of clamps by which the riser or vertical section of a saddle used to mount a bicycle onto the carrier is readily clamped to an endwall or sidewall of the truck bed. Each clamp includes a sleeve or collar which fits over the upper end of the riser and is lowered to the same level as the upper end of the endwall or sidewall. The clamp is then secured to a plate which abuts against the sidewall or endwall and is clamped to the wall. Because the plate is securely affixed to the endwall or sidewall, the riser is rigidly attached to the wall. When the carrier is removed, the riser is unclamped from the endwall or sidewall for disassembly and storage of the carrier.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIGS. 1A and 1B are plan views of a truck bed with a cargo carrier installed using the clamping mechanism of the present invention;

FIG. 2 is a side view of the mechanism as installed;

FIG. 3 is a plan view illustrating a saddle clamp and truck bed clamp of the mechanism;

FIG. 4 is an elevation view of the truck bed clamp;

FIGS. 5-9 illustrate alternate saddle clamp constructions;

FIGS. 10A-10C are front, rear, and side elevation views of a strap anchor for use in securing items to the carrier; and,

FIGS. 11 and 12 illustrate use of the anchor.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

The present invention comprises an improvement to a cargo carrier 10 such as described in my co-pending U.S. patent applications referred to above in which the carrier is removably installable in the bed B of a pickup truck T. The carrier is used to safely transport one or more bicycles, motorcycles, and other types of cargo from one from place to another, often over hazardous or difficult terrain. Carrier 10 includes a base plate 12 which extends substantially across the width of bed B. Base plate 12 is, for example, from 36-76″ in width, so to allow carrier 10 to be installed in trucks having beds of different sizes. For this purpose plate 12 may be of a single piece of the appropriate length, or it may be comprised of two or more telescoping sections, all as described in my previous applications.

Next, cargo carrier 10 includes pairs of saddles, three pairs of which (pairs 14, 16, and 18), are shown in the drawings installed in a side-by-side arrangement extending across the base plate. Each pair of saddles includes two spaced apart risers 14a-14b, 16a-16b, and 18a-18b, which are installed in slots (not shown) in base plate 12 and which have a section which extends vertically upwardly from the base plate generally parallel to a sidewall S or endwall E of the truck bed. The risers are curved risers whose curvature generally corresponds to that of a bicycle or motorcycle wheel with a base portion of the riser attached to base plate 12 in any convenient manner. When secured to the base plate and locked in place, the risers will not shift forward, backward, or sideways with respect to the base plate.

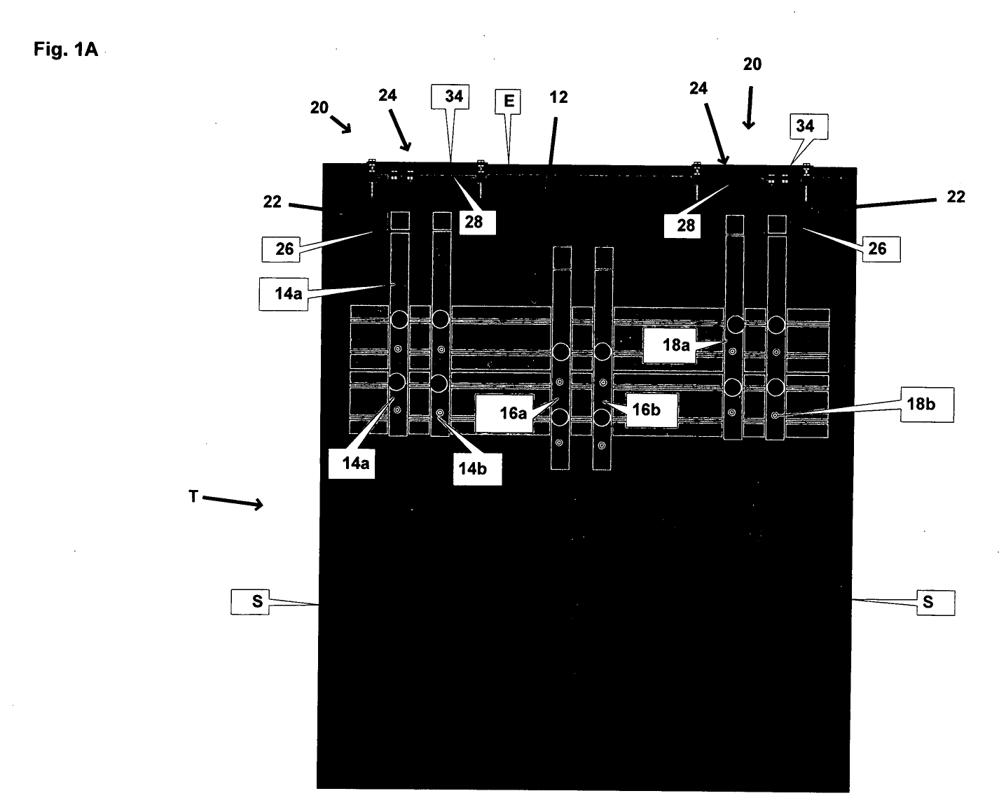

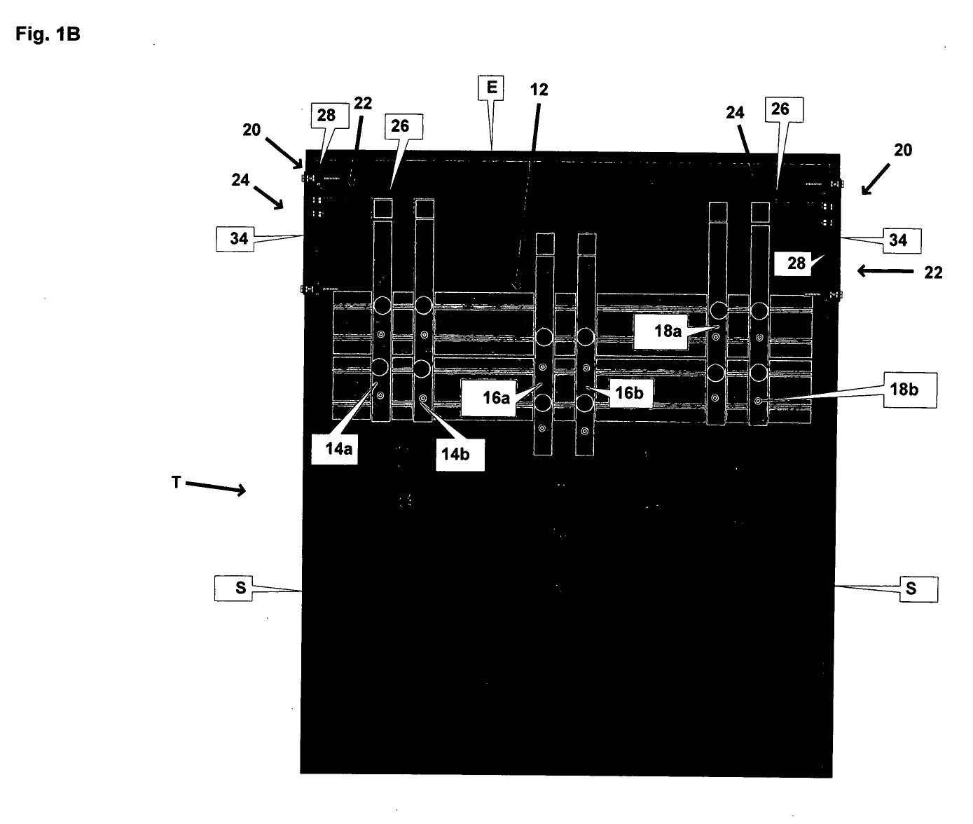

The improvement of the present invention is directed to a clamping mechanism, indicated generally 20, by which carrier 10 is securely fixed in place. The mechanism first includes a pair of saddle clamps 22 which, as shown in FIGS. 1A and 1B allow the outermost riser (14a and 18b) at each end of the arrangement of saddles to be attached to an endwall E or sidewalls S of the truck bed. As described hereinafter, each saddle clamp attaches to a truck clamp 24 that fits onto the endwall or sidewall.

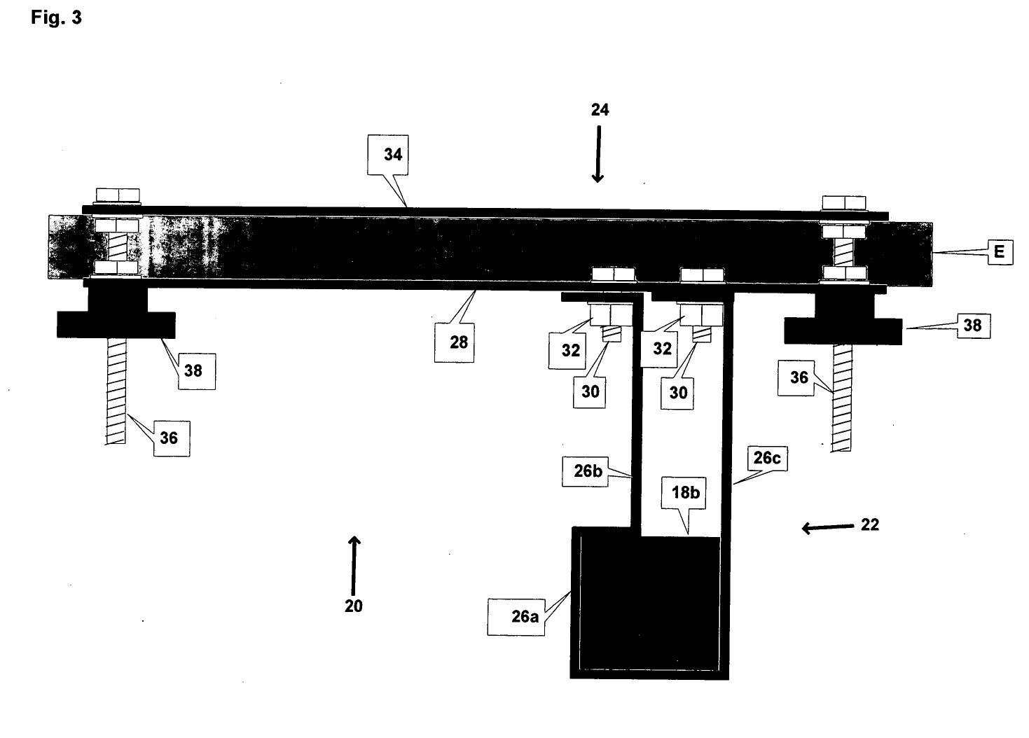

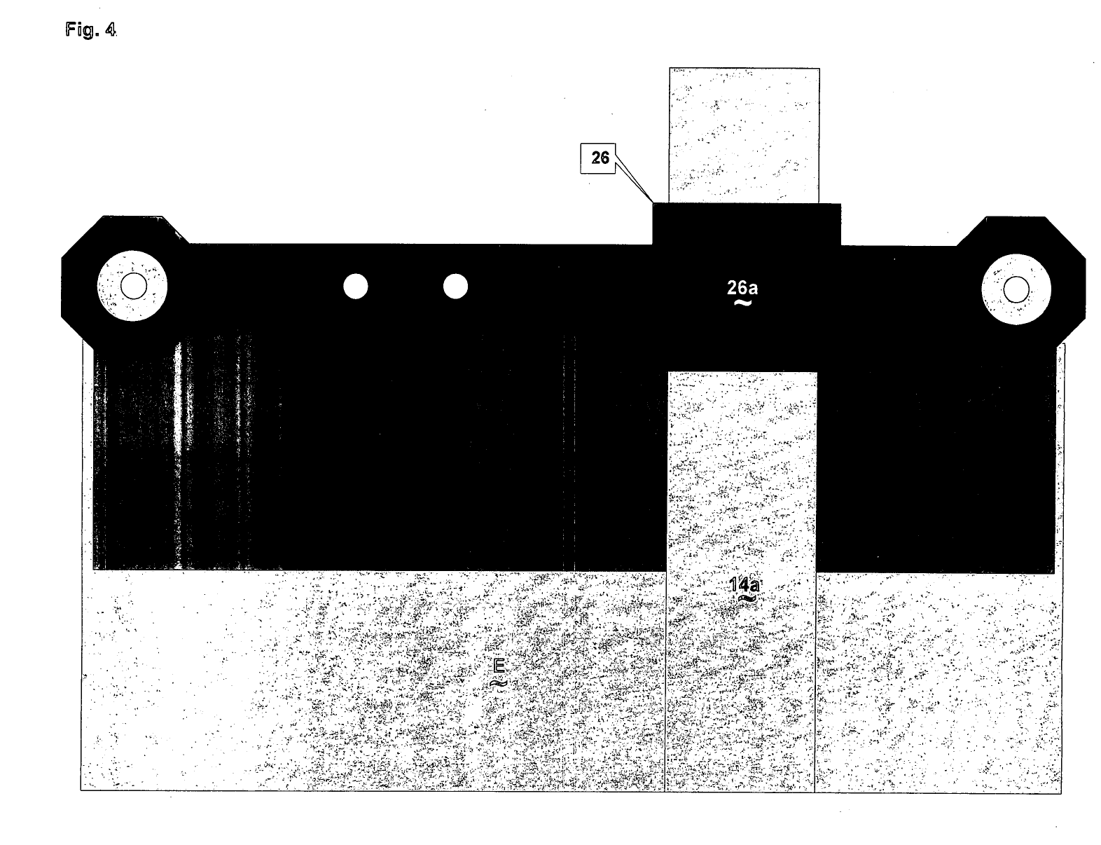

Saddle clamp 22 includes a bracket 26 having an outer generally rectangular sleeve or collar 26a sized to fit over the upper end of the vertical section of riser 18b (as shown in FIG. 3) and slide down over the outside of the riser so to encircle the riser. The bracket further has a pair of legs 26b, 26c which extend parallel to each other as shown in FIG. 3. The legs are each L-shaped with the longer portion of the leg extending from collar 26a of the bracket toward a clamping plate 28 of truck clamp 24. Plate 28 is a generally rectangular shaped plate one face of which abuts against the inside face of the truck's endwall or sidewall. The foot or base section of each bracket leg 26b, 26c abuts against an outer surface of plate 28, and there is a hole in each base section which corresponds in size with a hole in the upper portion of plate 28. (See FIG. 4) Once the base of the legs are set against the plate, the legs are secured to the plate using bolts 30 and nuts 32.

As shown in FIG. 3, plate 28 allows for two alternate locations for attaching a bracket 24 to the plate. In FIG. 3, the bracket 24 is fitted upper the upper end of saddle riser 18b with the bracket then being mounted to the right side of the plate. If the bracket were fitted onto the upper end of saddle riser 14a, then the bracket would be mounted onto the left side of the plate as indicated in the drawings. This means that the two plates 28 used with truck clamp 24 are interchangeable.

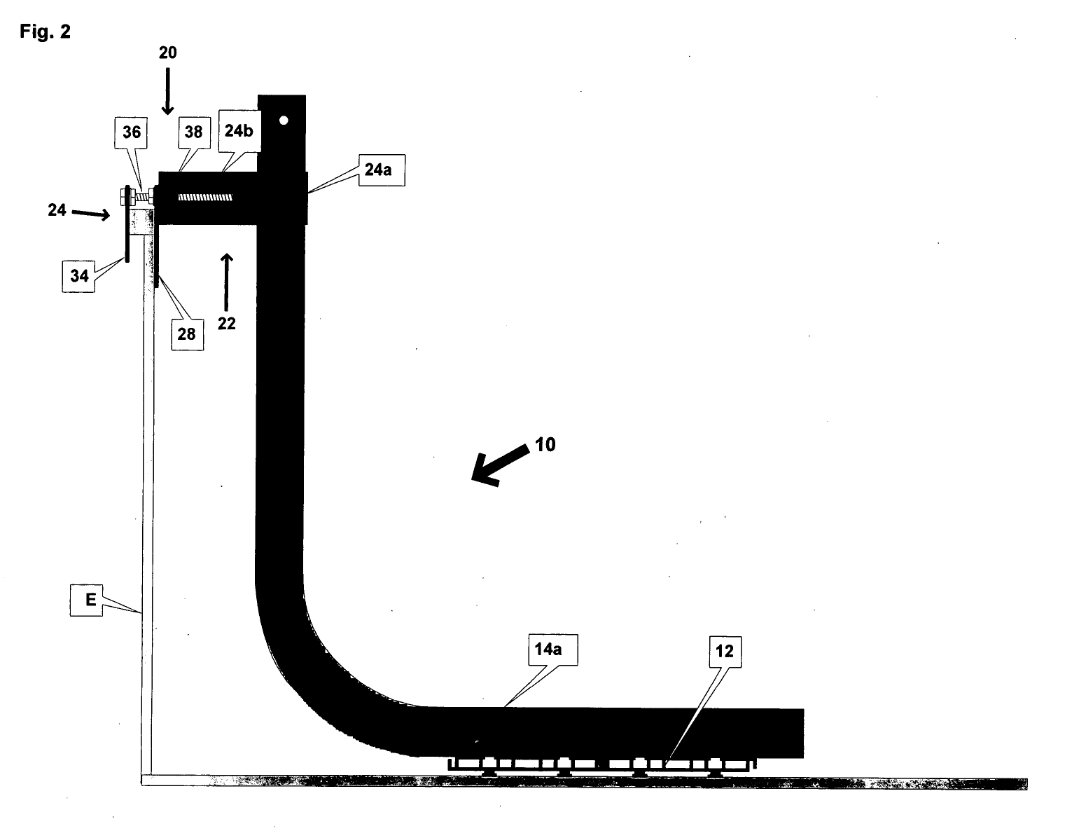

Truck clamp 24 includes a second plate 34 which abuts against the outside of the truck's endwall or sidewall. This second plate is as wide as plate 28, but shorter in height as shown in FIG. 2. Both of the plates have corresponding openings at their outer, upper ends. A pair of bolts 36 have their outer ends inserted through the openings in plate 34 with the threaded, shank potion of the bolts then being inserted through the corresponding openings in plate 28. A knob 38 is threaded onto the threaded end of each bolt and gradually tightened until plates 28 and 34 are clamped against the respective inner and outer surfaces of the trucks endwall or sidewall. This, in turn, clamps carrier 10 tightly in place so that it does not move about when the pickup is in motion. Now, when a bicycle, motorcycle, or other cargo is secured in place on carrier 10, it can be safely transported from one location to another.

The advantage of the clamping mechanism 20 in installing the cargo carrier to the truck bed is the ease of installation, and that no holes have to be drilled in the truck bed to secure base 12 (and the carrier) to the pickup. The only tools required for the installation are a wrench which can be provided in a kit which includes the parts of the carrier. Also, the installation is readily accomplished by one person and no great amount of physical strength is required. Similarly, when the carrier is taken down and stored, one person can quickly disconnect the risers from the endwall or sidewalls of the truck.

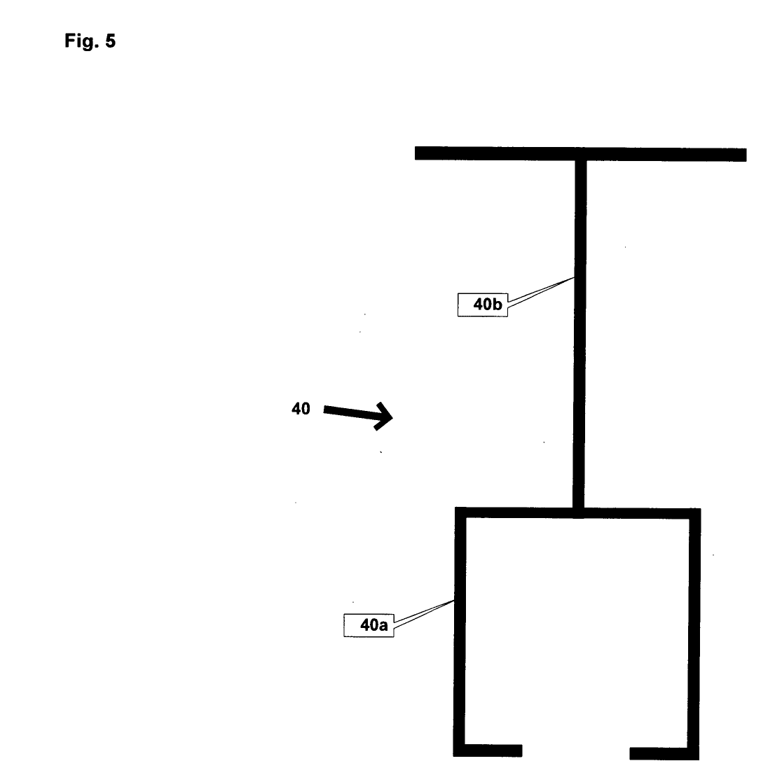

Next, referring to FIGS. 5-9, alternate riser clamps 40-48 respectively are shown. In FIG. 5, clamp 40 is similar to riser clamp 26 in that it is for use with a rectangular saddle riser. Now, collar 40a is formed together with only one leg 40b which is a T-shaped leg. Holes for use in attaching clamp 40 to plate 28 are formed on both sides of the base.

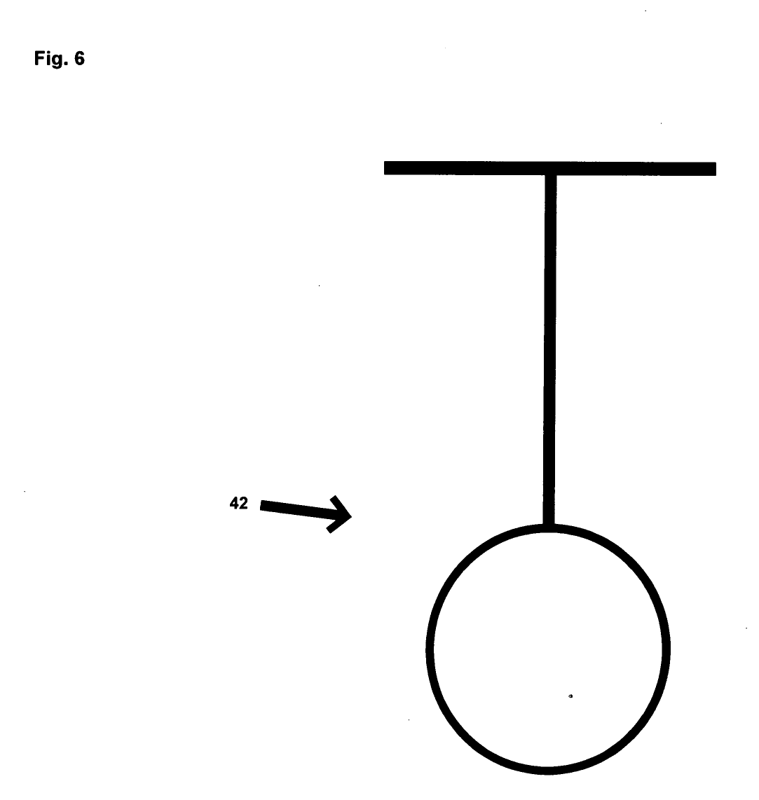

In FIG. 6, a clamp 42 is for use with a cargo carrier whose saddle risers are circular rather than rectangular in cross-section. Also, the collar comprises a completely closed, rather than an open collar. Again, the collar slides over the upper, vertical portion of the riser. Clamp 42, as with clamp 40 has only one leg which is a T-shaped leg. Holes for use in attaching clamp 42 to plate 28 are formed on both sides of the base.

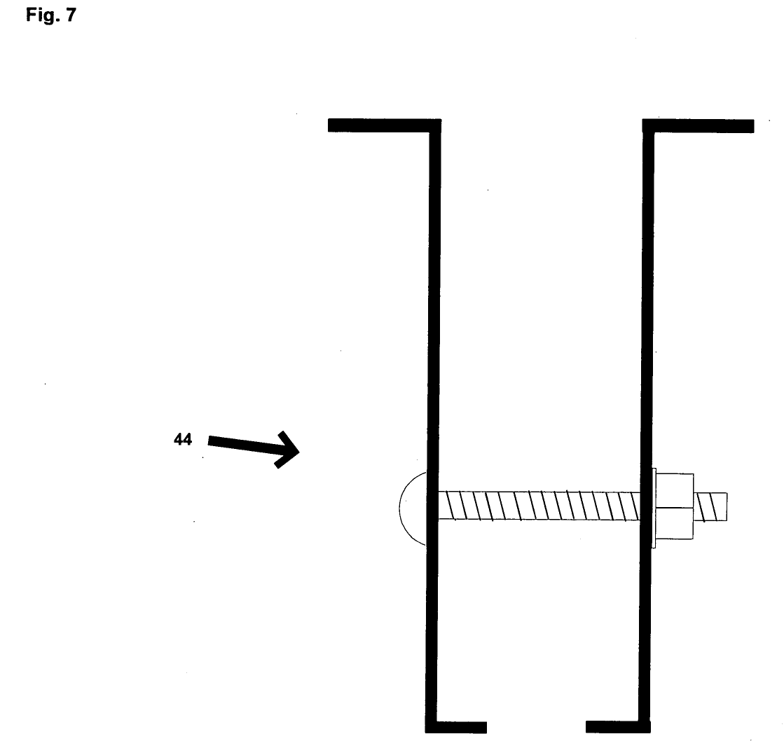

In FIG. 7, a clamp 44 comprises two Z-shaped members the outer ends of which fit about the upper end of a saddle riser. The two clamp members are connected together using a nut and bolt. The inner end of each member includes an opening for attaching the member to plate 28.

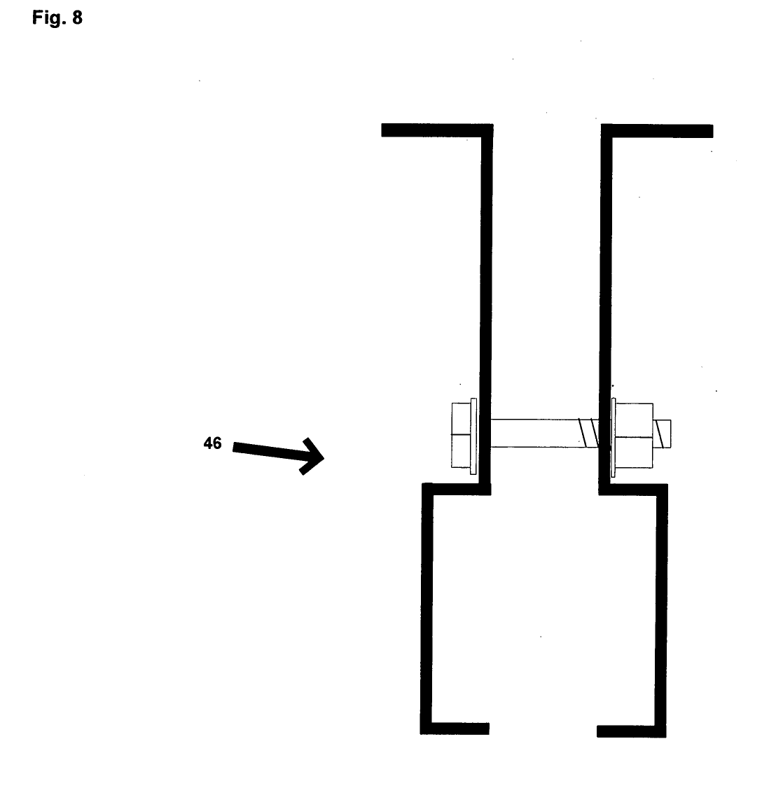

In FIG. 8, a clamp 46 comprises two members shaped to form an open, rectangular collar when fitted over the upper end of a riser. The two clamp members are connected together using a nut and bolt, and the inner end of each member includes an opening for attaching the member to plate 28.

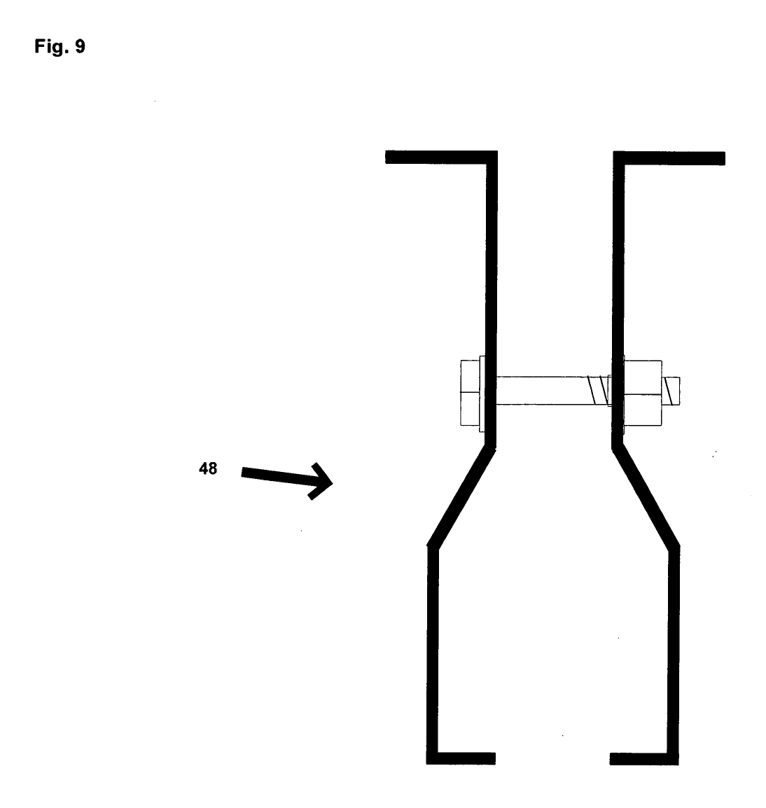

In FIG. 9, a clamp 48 is similar to clamp 46 except that each of two members shaped to form the open, rectangular collar when fitted over the upper end of a riser, have an intermediate, outwardly flaring section, this section beginning outwardly of where the two members are connected together using the nut and bolt. Again, the inner end of each member includes an opening for attaching the member to plate 28.

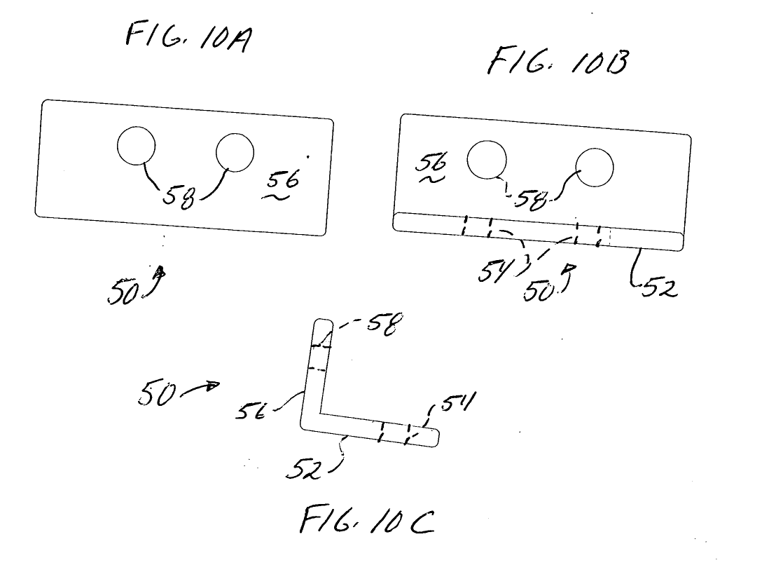

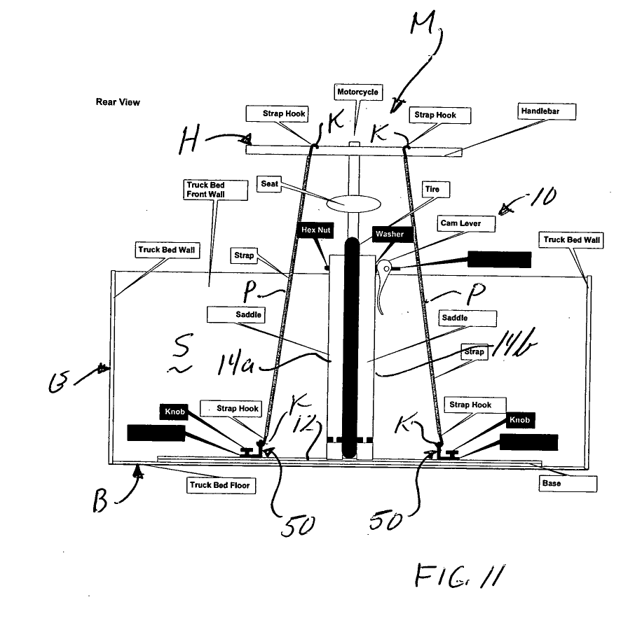

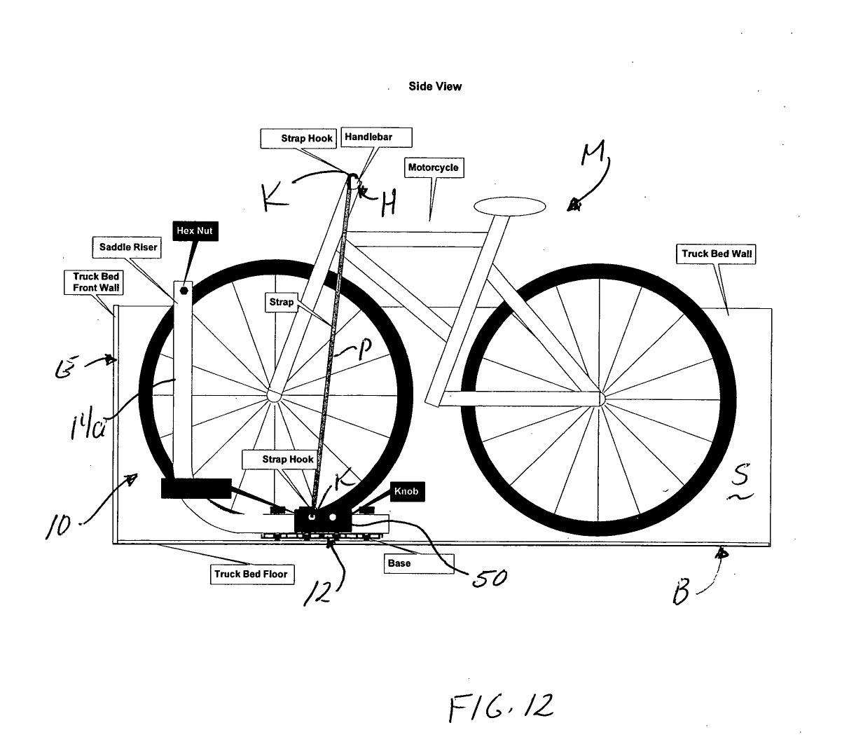

Finally, a strap anchor 50 is shown in FIGS. 10A-10C to be L-shaped having a base 52 in which are formed holes 54 for attaching the anchor to base plate 12 of carrier 10. An upright portion 56 of the anchor has holes or eyelets 58 formed in it. As shown in FIGS. 11 and 12, anchor 50 is shown attached to plate 12. When a motorcycle M, for example, is installed in carrier 10, the user may, as an option, attach a strap hook K at one end of a strap P to the handlebar H of the motorcycle, and insert the strap hook K at the other end of the strap into an eyelet 58 of anchor 50. The tension created by the straps creates an additional force for further securing the motorcycle on the carrier. This is especially helpful if, for example, the truck is driven over particularly rough terrain where the jostling to which the motorcycle is subjected might otherwise cause it to shift about too much within the carrier and perhaps damage the motorcycle or other items with which the motorcycle comes into contact. In this regard, and as shown in FIG. 12, a pair of strap anchors 50 are employed, the anchors being installed on opposites of the motorcycle.

In view of the above, it will be seen that the several objects and advantages of the present invention have been achieved and other advantageous results have been obtained.

Having thus described the invention, what is claimed and desired to be secured by Letters Patent is:

1. In a cargo carrier for installation in the bed of a pickup truck, the carrier used for transporting articles from one location to another and having a base plate and a saddle fitted to the base plate for supporting one end of an article during transport of the article, a clamping mechanism for attaching a riser of the saddle to a sidewall of the truck comprising:
a saddle clamp one end of which fits about the riser to hold the riser in place; and,
a truck clamp which attaches to the sidewall and to which the saddle clamp is attached.

2. The clamping mechanism of claim 1 in which the carrier includes a plurality of saddles in a side-by-side arrangement, each saddle including a pair of risers, and the mechanism includes a saddle clamp fitting over the outer riser at each end of the arrangement.

3. The clamping mechanism of claim 2 in which each riser includes a vertical section extending upwardly parallel to the sidewall and each saddle clamp includes a bracket having a collar fitting over an upper end of the riser to encircle the riser.

4. The clamping mechanism of claim 3 in which the collar is an open collar.

5. The clamping mechanism of claim 3 in which the collar is a closed collar.

6. The clamping mechanism of claim 3 in which the bracket further includes at least one leg formed with the collar and extending therefrom for attachment of the bracket to the truck clamp.

7. The clamping mechanism of claim 6 in which the truck clamp includes a first plate and a second plate, one of the plates being mounted on the inside of the sidewall and the other plate being mounted on the outside thereof.

8. The clamping mechanism of claim 7 in which the bracket is secured to plate mounted on the inside of the sidewall.

9. The clamping mechanism of claim 8 further including tightening means interconnecting the first and second plates and for tightening the plates against the sidewall so to hold the carrier in place.

10. The clamping mechanism of claim 9 in which the tightening means includes a pair of bolts each of which is inserted through opening in one of the plates with a threaded, shank potion of the bolts then being inserted through corresponding openings in the other plate, and a knob threaded onto the threaded end of each bolt and gradually tightened until the plates are clamped against respective inner and outer surfaces of the sidewall.

11. The clamping mechanism of claim 8 in which the plate mounted on the inside of the sidewall has at least one opening at each end thereof for attachment of a bracket to the plate whereby the plate is used interchangeably to attach the outer riser at each end of the arrangement to the truck clamp.

12. The clamping mechanism of claim 3 in which the riser is rectangular in cross-section and the collar is a rectangular shaped collar.

13. The clamping mechanism of claim 3 in which the riser is circular in cross-section and the collar is a circular shaped collar.

14. The clamping mechanism of claim 1 further including a strap anchor attached to the base plate for attaching one end of a strap to the anchor, the other end of the strap being connected to an object installed in the carrier.

15. The clamping mechanism of claim 14 further including a pair of strap anchors installed on the base plate on opposite sides of the object.

16. The clamping mechanism of claim 15 in which the strap anchor is generally L-shaped with a base in which are formed holes for attaching the anchor to the base plate.

17. The clamping mechanism of claim 16 in which the strap anchor further has an upright portion in which eyelets are formed, the one end of the strap being fitted into the eyelet.
